(19) United States
(12) Patent Application Publication
(10) Pub. No.: US 2026/0008057 A1
(43) Pub. Date: Jan. 8, 2026

(54) LIQUID SAMPLE VIAL, ASSEMBLY AND METHOD FOR CONVEYING A LIQUID SAMPLE

(71) Applicant: ELYSIA, Liège (BE)

(72) Inventors: Clément NOTERMANS, Esneux (BE); David THONON, Tilff (BE); Bertrand BECKERS, Amay (BE)

(73) Assignee: ELYSIA, Liège (BE)

(21) Appl. No.: 19/254,199

(22) Filed: Jun. 30, 2025

(30) Foreign Application Priority Data
Jul. 8, 2024 (BE) BE2024/5432

(51) Int. Cl. B01L 3/00

(52) U.S. Cl. CPC B01L 3/50825; B01L 2300/0832; B01L 2300/0858; B01L 2300/0861

(57) ABSTRACT

The present disclosure relates to a vial for receiving a liquid sample, the vial can include an inner volume and a body with a lateral wall, the body delimiting the inner volume, the vial configured to receive the sample in the inner volume. The vial can further include an upper opening in the body, a plug for closing the upper opening, a septum coupled to the plug, the septum configured to be pierced by a sampling needle for taking the sample, and a lateral duct through the lateral wall. The lateral duct can be configured to connect the vial to a tube for transferring the sample in the inner volume of the vial.

### TECHNICAL FIELD

The present disclosure relates to a vial suitable for receiving a liquid sample to be analyzed, an analysis assembly and a method for conveying the liquid sample.

### BACKGROUND

In the field of analysis of chemical compounds in a liquid, using an analysis apparatus such as a chromatography analysis apparatus, a liquid sample is presented in a vial by an operator. The operator handles the vial and the sample so that the sample may be conveyed to the analysis apparatus for treatment. Such handling may present a risk of human error.

Therefore, there is a need to increase the reliability of the transfer of a liquid sample for analysis.

### SUMMARY

The present disclosure proposes a vial for receiving a liquid sample, the vial comprising an inner volume and a body with a lateral wall, the body delimiting the inner volume, the vial being adapted to receive the sample in the inner volume, an upper opening in the body, a plug for closing the upper opening, a septum coupled to the plug, the septum being adapted to be pierced by a sampling needle for taking the sample, a lateral duct through the lateral wall, the lateral duct being adapted to connect the vial to a tube for transferring the sample in the inner volume of the vial.

In an embodiment, the vial comprises a single lateral duct.

In an embodiment, the vial further comprises an insert in the inner volume, the insert having an internal volume reducing the inner volume of the vial, the insert comprising a passage facing the lateral duct, the lateral duct and the passage being adapted to connect the vial to the sample transfer tube in the internal volume of the insert.

In an embodiment, the inner volume of the vial is between 1 mL and 3 mL and the internal volume of the insert is between 10 μL and 600 μL.

In an embodiment, the insert is made of thermoformed polymer.

In an embodiment, the insert has a wall with a smooth inner surface.

In an embodiment, the lateral duct is lower than the plug.

In an embodiment, the body comprises an interface for attaching the plug, the lateral duct being lower than the attachment interface, the attachment interface can include being a screw thread.

In an embodiment, the lateral wall of the body comprises a mistake-proofing device, which can be in the form of a flat, the mistake-proofing device being adapted to orient the vial.

In an embodiment, transversely to the height, the body comprises an essentially cylindrical top section and a bottom section shaped cylindrically, spherically or conically.

The present disclosure also relates to an analysis assembly comprising an apparatus for analyzing a liquid sample, the vial as described hereinbefore and a tube for transferring the sample, the assembly being adapted to convey the sample towards the analysis apparatus via the vial by the transfer tube connected to the vial by the lateral duct, and the transfer tube optionally being held by clamping in the lateral duct.

In an embodiment, the assembly also comprises a sampler supporting the vial, the positioning of the vial with respect to the sampler being imposed by a mistake-proofing device.

In an embodiment, the analysis apparatus is a gas chromatography or high-performance liquid chromatography analysis apparatus.

The present disclosure also relates to a method for conveying a liquid sample towards an analysis apparatus via the vial as described hereinbefore, the method comprising connecting a transfer tube to the vial via the lateral duct, transferring the sample into the vial via the transfer tube, inserting a sampling needle through the septum, taking the sample to be analyzed by the analysis apparatus from the vial through the septum via the needle.

In an embodiment, the vial further comprises an insert in the inner volume, the insert having an internal volume reducing the inner volume of the vial, the method further comprising transferring the sample into the internal volume of the insert by the transfer tube connected to the vial by the lateral duct of the vial and by a passage in the insert facing the lateral duct, and taking the sample from the internal volume of the insert through the septum via the needle.

In an embodiment, a sampler supports the vial and the lateral wall of the body of the vial comprises a mistake-proofing device, which can be in the form of a flat, the positioning of the vial with respect to the sampler being imposed by the mistake-proofing device.

In an embodiment, the volume of the sample transferred to the vial is between 10 μL and 1 mL, and the volume of the sample taken from the vial is between 0.1 μL and 100 μL.

In an embodiment, the sample is transferred towards the vial remotely.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a schematic view of a vial in accordance with embodiments of the present disclosure;

FIG. 2 shows a schematic view of a part of the vial of FIG. 1;

FIG. 3 shows a schematic exploded view of the vial of FIG. 1; and

FIG. 4 shows another schematic view of the vial of FIG. 1.

The drawings in the FIGURES are not to scale. Similar elements are generally denoted by similar references in the FIGURES. In the scope of this document, the same or similar elements may have the same references. Furthermore, the presence of reference numbers or letters in the drawings may not be considered as limiting, even when these numbers or letters are indicated in the claims.

### DETAILED DESCRIPTION

The detailed description set forth herein connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

The present disclosure relates to a vial suitable for receiving a sample of liquid to be analyzed. The vial comprises an inner volume and a body with a lateral wall, the body delimiting the inner volume. The vial is adapted to receive the sample in its inner volume. The vial also comprises an upper opening in the body, a plug for closing the upper opening and a septum coupled to the plug, the septum being adapted to be pierced by a sampling needle for taking the sample. A lateral duct through the lateral wall is adapted to connect the vial to a sample transfer tube in the inner volume of the vial. Such a vial facilitates the transfer of the sample towards an analysis apparatus, as it is shaped to receive a sample to be analyzed and to extract the sample towards the analysis apparatus. Such a vial permits an automatic transfer of the sample towards an analysis apparatus. Such a vial reduces the risk of human error, thereby increasing the reliability of the transfer of the sample to be analyzed.

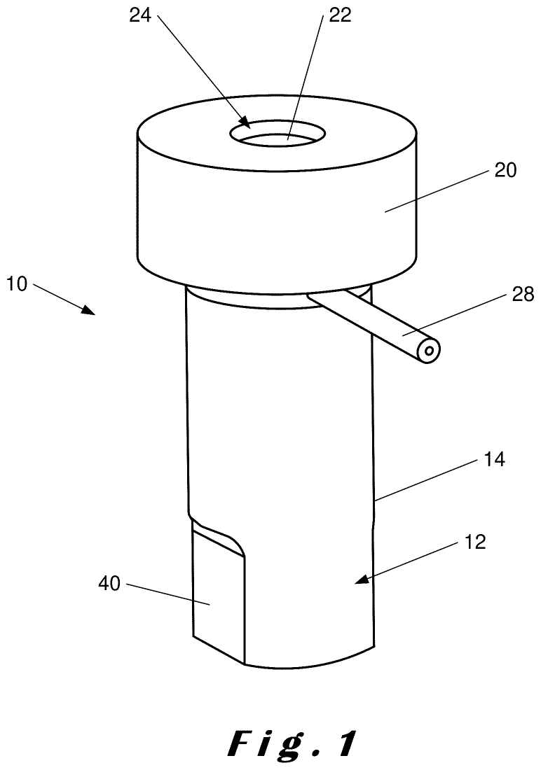

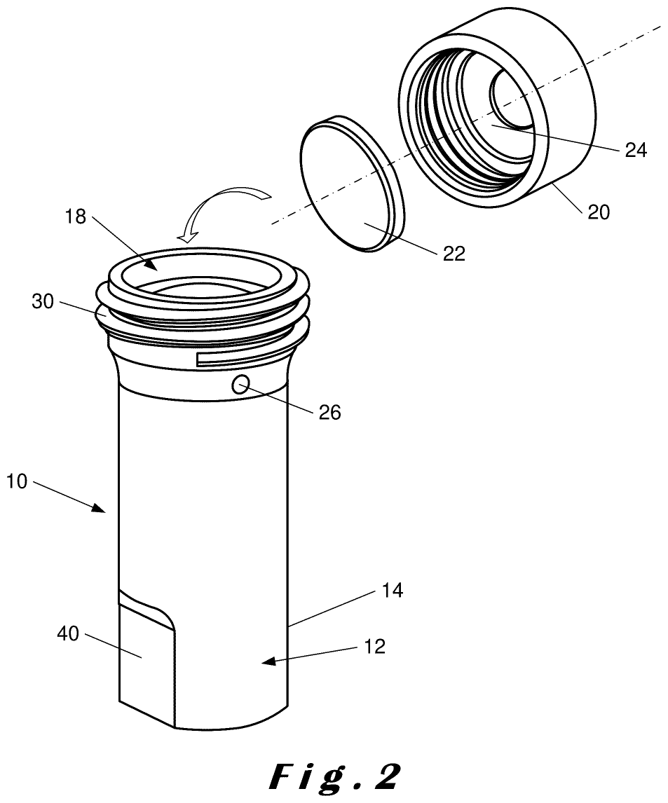

FIG. 1 shows a schematic view of the vial 10 and FIG. 2 a schematic view of a part of the vial 10. The vial 10 is used to receive a liquid sample in order to proceed to an analysis of the sample. The sample is configured to be analyzed in an analysis apparatus.

The vial 10 includes a body 12 with a lateral wall 14. The body 12 may be cylindrical or essentially cylindrical in shape. The body 12 delimits an inner volume 16 through its lateral wall 14. The inner volume is adapted to receive the sample. The vial 10 comprises an upper opening 18 in the body 12. The upper opening 18 provides an access to the inner volume 16. A plug 20 on the vial permits closing the upper opening 18.

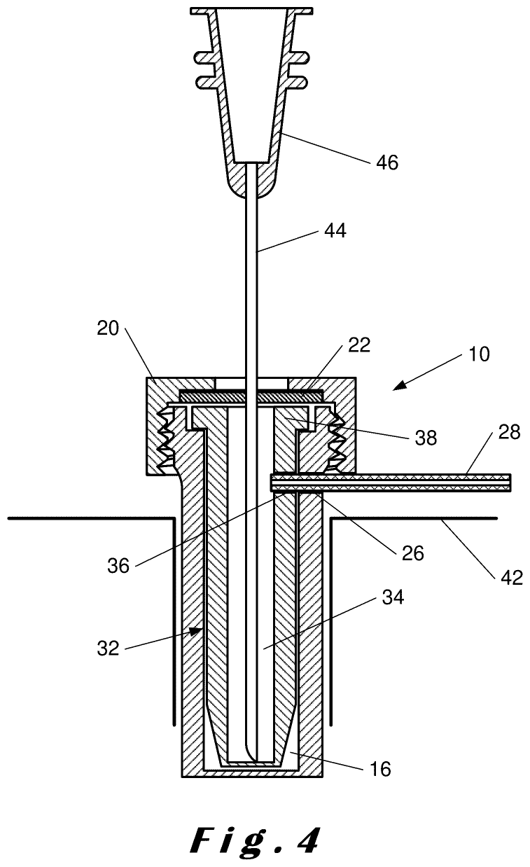

The vial 10 also includes a septum 22 (mechanically) coupled to the plug 20. The septum 22 is a membrane that is adapted to be pierced by a sampling needle for taking the sample. The septum 22 provides an access to the inner volume 16, while keeping the inner volume 16 closed by the plug 20. In some embodiments, the plug 20 is provided with an orifice 24 through its upper face, the orifice 24 being closed by the septum 22 once the plug 20 is in place on the body 12. FIG. 4 shows another schematic view of the vial 10 and in some embodiments the positioning of the septum 22. Once the plug 20 is in place on the body 12, the septum 22 is sandwiched between the plug 20 and the edge of the upper opening 18 of the body. The septum 22 is thus held in place and closes the orifice 24. The inner volume 16 is then closed, but accessible by piercing a needle 44 of a syringe 46. The septum 22 may be a membrane made of a plastic material such as silicone, rubber, PTFE, butyl or Viton, or a combination of several of these materials. The septum 22 may be a membrane in the form of a disc to fit inside the plug 20 and be coupled to the plug 20. Several sizes of septum 22 are possible, in some embodiments to fit the plug 20 and the body 12.

The vial 10 also comprises a lateral duct 26 through the lateral wall 14. The lateral duct 26 is adapted to connect the vial 10 to a sample transfer tube 28 in the inner volume 16 of the vial 10. The lateral duct 26 passes through the lateral wall 14 of the body 12. The lateral duct 26 permits the transfer tube 28 to be connected to the vial 10 and the sample to be transferred from the outside of the vial 10 towards the inner volume 16—for example from a primary container with a larger volume of liquid. This permits repeating a sample transfer without the operator having to handle the vial 10. This also permits the sample to be transferred remotely into the vial 10. For example, the transfer tube 28 may be used to transfer the sample over a distance of several meters, and the transfer tube 28 may be from 1 to 10 meters long. The sample may also be transferred automatically into the vial 10, without human intervention. The sample may be radioactive, so an automated, remote transfer offers the advantage of protecting the operator. Embodiments of the present disclosure permit the vial to be transferred or filled remotely and offers an advantage in terms of radiation protection of the automation (no risk of contamination and no proximity between operator and radioactive solution). Embodiments of the present disclosure therefore permit reducing the risks of exposure to radioactivity, but also to protect the operator during the transfer of samples in any applications that are toxic to the operator (cytotoxic, heavy metals, etc.). The automatic transfer also eliminates the need for the operator to handle the vial, for example by removing the plug to transfer the sample into the vial. This reduces the risk of error.

The vial 10 is a vial for receiving a volume of sample. The vial 10 may receive a volume of sample to be analyzed without requiring continuous circulation of the sample volume within the inner volume 16 of the vial 10. This makes it easier to take the volume of sample to be analyzed from the vial 10, avoiding any possible recovery and treatment of the volume of sample after it has been taken. This also permits a more precise handling of the sample volume.

In some embodiments, the absence of continuous circulation permits the volume of liquid transferred to be reduced or limited. This can be advantageous when the transferred liquid is radioactive. Limiting the quantity of radioactive liquid reduces the risk of human operators being exposed to radioactivity and therefore offers an advantage in terms of radiation protection (or radioprotection). In addition, the transferred liquid may be expensive. In this case, limiting the amount of transferred liquid reduces the cost of the transfer. Furthermore, a continuous circulation system requires the installation of a return (or extraction) line (or tube) for the liquid from the internal volume 16 of the vial 10 to the outside of the vial 10. Such a return line has the disadvantage of increasing the volume of sample lost, or “dead volume.” In contrast, in the present disclosure, where the vial 10 is a vial for receiving a sample volume, it is possible to purge a tube for transferring a sample with air rather than with an additional volume of liquid, which offers the advantage of reducing or limiting the volume of sample lost. Finally, a continuous circulation system requires the installation of equipment that is permanently dedicated to the circulation of the liquid in the system. This has the disadvantage of increasing the installation, operating, and maintenance costs of the sample transfer system.

The vial 10 permits an adjusted volume of sample to be received. In some embodiments, the vial 10 may receive a volume of sample adjusted to the sampling requirements. More specifically, the vial 10 may receive a volume of sample adjusted to a volume taken by the needle 44. The vial 10 thus permits a more precise handling of the sample volume. One advantage of receiving an adjusted sample volume is to limit the volume of sample transferred towards the inner volume 16 from outside the vial 10. It may not be possible to reuse the volume transferred, for example to limit the risk of contamination. After the sampling, the residual part of the volume transferred constitutes a residue. It may be necessary to recover and/or treat this residue in a specific way, which has a cost, such as in the case of a radioactive liquid sample. Receiving an adjusted volume in the vial 10 limits or even avoids any recovery and possible treatment of the residue as well as the costs associated with these operations. Moreover, the residue may be lost and thus become a waste. It may be necessary to treat this waste in a specific way, which has a cost, such as in the case of a radioactive liquid sample. Consequently, receiving an adjusted volume of sample in the inner volume 16 of the vial 10 permits limiting the quantity of waste associated with the sampling as well as the cost of any treatment of this waste.

In some embodiments, the vial 10 comprises a single lateral duct 26. In this case, the vial 10 comprises only one lateral duct 26. The single lateral duct 26 is adapted to connect the vial 10 to a tube 28 for transferring the sample into the inner volume 16 of the vial 10, in order to convey the sample into the inner volume 16 of the vial 10. In other words, the single lateral duct 26 permits the sample to be conveyed, or brought, towards the inner volume 16 of the vial 10 from outside the vial 10. In this case, the vial 10 comprises no other lateral duct permitting the sample to be conveyed, or brought, towards the inner volume 16 of the vial 10 from outside the vial 10. The sample may then be taken, or extracted, from the inner volume 16 of the vial 10, for example by a needle 44 through the upper opening 18 of the body 12 of the vial 10. In this case, a reduced volume of sample may be conveyed into the inner volume 16 of the vial 10, this reduced volume corresponding in some embodiments to a volume of sample taken by the needle 44. This configuration, wherein the vial 10 comprises a single lateral duct 26, does not permit a continuous circulation of liquid through the inner volume 16 of the vial 10. One advantage of this configuration is that it reduces the volume of sample required for taking compared with a configuration permitting a continuous circulation of liquid through the inner volume 16 of the vial 10, as described hereinabove.

In addition, as the duct 26 is positioned laterally to the vial, i.e. through the lateral wall 14, the upper part of the vial is not cluttered. In some embodiments, this results in the plug 20 not being cluttered by the presence of an inlet channel for the sample through the plug-which is complex to achieve because of the orifice 24 and the presence of the septum 22. As the duct 26 is positioned laterally, it does not impede the insertion of the needle 44 through the septum 22. In addition, the reliability of the transfer of the sample towards the inside of the vial 10 through the lateral duct 26 (or even automatically) also permits a small liquid samples to be transferred directly and reliably, as indicated elsewhere. They may also be samples of radioactive liquid. Such a vial 10 makes the sample transfer solution universal, regardless of the analysis apparatus, which does not need to be adapted. For example, there is no need to adapt the clearance above the vial and/or the space for the movement of sampling members (such as the syringe 46). This solution does not affect the analysis performance. It is a plug-and-play solution. The transfer tube 28 is made of PTFE, for example.

The body 12 is produced by molding or 3D printing, for example. The lateral duct 26 may be obtained by piercing. Transversely to the height, the body 12 may comprise an essentially cylindrical (or even cylindrical) top section and a bottom section shaped in the same or a different way. The bottom section may be cylindrical for ease of manufacture. The bottom section may be spherical to increase the inner volume. The bottom section may also be conical to permit a more efficient sample taking, specifically for small volumes.

The body 12 may comprise an interface 30 for attaching the plug 20. This keeps the inner volume 16 closed. The attachment interface 30 is, for example, a screw thread (easy to use) or a clip attachment. The plug 20 is shaped to fit over such an attachment interface 30. The attachment interface 30 is shaped on the lateral wall 14, at the upper end of the lateral wall 14, according to the height of the vial 10. The attachment interface is used to close off the upper opening 18.

In order not to impede the positioning of the plug 20 on the body 12, the lateral duct 26 is lower than the plug 20. In other words, the lateral duct 26 is in a position level with the lower edge of the plug 20, once the plug 20 is in place on the body 12. In this way, the lateral duct 26 does not interfere with the plug 20. Advantageously, with the lateral duct 26 in a position level with the lower edge of the plug 20, this permits the lower edge of the plug to slightly compress the transfer tube 28 once in place in the lateral duct 26, thereby helping to hold it in place. The transfer tube 28 may also be clamped in the lateral duct 26. The transfer tube 28 may be held in place, for example, even in the presence of vibrations. It may also be preferable in some embodiments for the lateral duct 26 to be lower than the attachment interface 30. In other words, depending on the height of the vial 10, the lateral duct 26 is in a lower position than the attachment interface 30. This ensures that there are no obstructions to opening or closing the plug 20. However, the lateral duct 26 is high enough so that the volume of sample transferred into the vial does not reach the lateral duct 26—to avoid overflow.

In an embodiment, the vial 10 may further comprise an insert 32. The insert 32 has an internal volume 34 which reduces the inner volume 16 of the vial 10. The insert 32 thus permits modularization of the sample reception volume. Depending on the choice of insert in the vial, the volume of sample received is adjusted. The insert 32 may also comprise a passage 36 facing the lateral duct 26. The passage 36 is through the wall of insert 32. The lateral duct 26 and the passage 36 are then adapted to connect the vial 10 to the sample transfer tube 28 in the internal volume 34 of the insert 32. Once the insert is in place in the body 12, the lateral duct 26 and the passage 36 are aligned, permitting the transfer tube 28 to be inserted. The advantages of the vial mentioned elsewhere in this document also apply here.

The insert 32 may be made of (thermoformed) polymer, such as (thermoformed) polypropylene, which makes it easy to handle and not very fragile. This also makes it easier to create the passage 36, for example by piercing. It may be a high purity polymer (with a reduced risk of contamination from the liquid transferred to the insert). The insert 32 is also essentially cylindrical (or even cylindrical) and fits into the inner volume 16 of the vial. The bottom of the insert may also be cylindrical or conical for a more efficient sample collection.

The insert 32 may be introduced into the inner volume 16 of the vial 10 through the upper opening 18. The insert 32 may comprise a collar 38 at its upper end. The collar 38 rests on a rim of the body, around the upper opening 18. It is conceivable that the septum 22 sandwiched between the plug 20 and the edge of the upper opening 18 of the body also rests against the collar 38 once the plug 20 is in place-which permits immobilization of the elements of the vial 10 with one another. The insert 32 thus allows, on the one hand, the connection with the transfer tube 28 for transferring a sample into the internal volume 34 of the insert 32 and, on the other hand, the needle 44 to pierce the septum 22 and take the sample from the internal volume 34 of the insert 32. The insert 32 has a wall with a smooth inner surface. The liquid sample and any droplets flow properly towards the bottom of the insert 32. This avoids air bubbles trapped at the bottom of the insert and maximizes sample recovery.

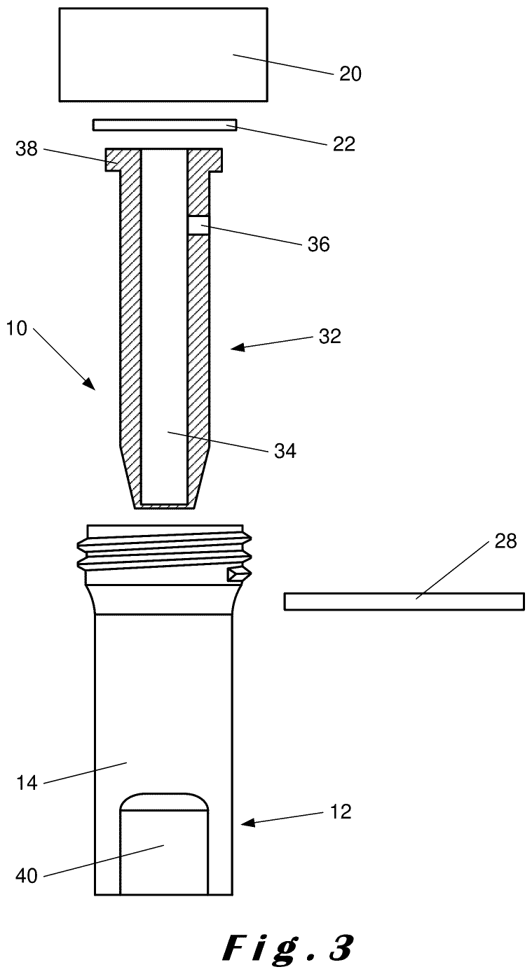

As may be seen in FIGS. 1-3, the lateral wall 14 of the body 12 may comprise a mistake-proofing device 40. Herein, a mistake-proofing device (or foolproof device) is a mechanical device (or part) that prevents assembly or misalignment error. The mistake-proofing device 40 is adapted to give the correct orientation to the vial 10. The mistake-proofing device 40 determines the position of the vial 10. In some embodiments, once the vial 10 is in place in a sampler (such as in FIG. 4 where a support 42 is schematically shown) of an analysis apparatus, the vial 10 is suitably oriented for the sample transfer into the vial 10 via the transfer tube 28 and for the sample taking via the needle 44. The mistake-proofing device 40 may be a flat or a groove. The mistake-proofing device 40 is at a lower end of the vial, so that the vial is oriented as soon as the vial is inserted into the sampler.

The vial may be a kit comprising the body 12, the plug 20 and the septum 22 as well as a set of several inserts 32 (the inserts having the same and/or different volumes). The vial is modular, with or without an insert, and if necessary with inserts that adjust the internal volume according to the insert in place. In this case, changing the insert permits the sample reception volume to be adapted.

The present disclosure also relates to an analysis assembly comprising an apparatus for analyzing a liquid sample, a sampler, the vial 10 and the transfer tube 28. The apparatus permits samples (such as liquid samples) to be analyzed by chromatography, for example. This may be gas chromatography, high-performance liquid chromatography, etc. The analysis apparatus is supplied with the liquid to be analyzed from the vial 10. The transfer tube 28 is connected to the vial 10 via the lateral duct 26, in some embodiments via the single lateral duct 26. The assembly is adapted to convey the sample towards the apparatus by the vial 10 supported by the sampler. The sampler may comprise the support 42 for supporting one or more vials 10 (for example a rack or a carousel) and a sampling member such as the syringe 46 equipped with the needle 44. The support 42 presents the vial or vials to the needle 44. The movements of the sampling member may be automated. The sampler may be described as an automatic sampler. Any conveying (comprising the transfer towards the vial and the injection into the analysis apparatus) of the sample towards the analysis apparatus may be carried out automatically, further reducing the risk of error and increasing the reliability of the transfer.

The present disclosure also relates to a method for conveying a liquid sample to an analysis apparatus, implementing the vial 10. The conveying method is applicable to the assembly described above. The sample may come from a container comprising a larger volume of the liquid to be analyzed. The transfer tube 28 is connected to the vial 10 via the lateral duct 26, in some embodiments via the single lateral duct 26. The transfer tube 28 may be connected to the vial 10, which may already be in place on the sampler. The liquid sample is transferred from the container to the vial via the transfer tube. The sampling needle 44 is then inserted into the vial through the septum 22. This permits the sample to be analyzed by the analysis apparatus to be taken from the vial 10 through the septum 22 via the needle. The sample taken by the needle is then injected into the analysis apparatus. The method helps to reduce human handling errors and thus increases the reliability of the conveying of the sample to be analyzed, and in some embodiments, increases the reliability of the transfer of the sample towards the vial. As mentioned above, the method permits a transfer from a distance (a few meters, for example 1 to 10 meters) towards the vial, without moving the mother vial, and therefore offers a radiation protection to the operator or any other protection (when the sample is radioactive or toxic in general). The conveying method may be remote and automatic.

The sample is transferred to the inner volume 16 of the vial (before being taken). In the embodiment with the insert 32, the transfer tube 28 is connected to the vial 10 via the lateral duct 26 of the vial and via the passage 36 of the insert facing the lateral duct 26. With or without an insert, the transfer tube is connected to the vial in such a way as to permit the needle to pass freely through the septum 22 and into the inner volume 16 (or internal volume 34 if applicable). According to FIG. 4, the end of the transfer tube inserted into the lateral duct 26 of the vial, and into the passage 36 if applicable, is positioned so as to be flush with the inner surface of the body 12 (or of the insert 32 if applicable). The needle is free to pass through the vial. This permits delivery of the sample in a sealed manner without hindering the introduction of the needle taking the sample, which may reach the bottom of the inner volume 16 or the internal volume 34.

More specifically, the vial 10 may be supported by the sampler. The sampler permits the vial 10 to be presented for taking sample by the needle. In some embodiments, the mistake-proofing device 40 (or mistake-proofing system) permits the vial 10 to be correctly oriented and positioned. To achieve this, the vial 10 may comprise the mistake-proofing device 40 on its lateral wall 14, the positioning of the vial 10 relative to the sampler being dictated by the mistake-proofing device 40. The vial 10 is correctly oriented in the sampler, permitting a reliable transfer of the liquid sample towards the analysis apparatus.

Embodiments of the present disclosure permit a sample transfer towards the vial 10 to be repeated and/or sampling from the vial 10 and sample injection towards the analysis apparatus to be repeated. These repetitions are carried out reliably.

The present disclosure may be suitable for small volumes of liquid samples to be analyzed, and therefore small vials. The volume of the sample transferred into the vial 10 may be between 10 μL and 1 mL, and the volume of the sample taken from the vial for injection into the analysis apparatus may be between 0.1 μL and 100 μL, in some embodiments 0.5 μL (with an error of less than 5%). The body 12 is such that the inner volume 16 of the vial 10 may be between 1 mL and 3 mL, typically 2 mL. The dimensions of the body (excluding plug 20) are, for example, 22 mm to 35 mm high. The outer diameter of the plug is between 15 mm and 25 mm. The internal volume 34 of the insert 32 is, for example, between 10 μL and 600 μL. The choice of the size of the elements depends on the volumes to be transferred. The dimensions and volumes involved are such that the movement of the elements contributing to the sample transfer is limited. The presence of the lateral duct 26 on the lateral wall 14 permits freeing of the space above the vial 10 for the needle to move, for example, while leaving the needle free to pass through the vial. The vial 10 is easy to assemble and inexpensive, which reduces the cost of the transfer.

In addition, the present disclosure permits the remote transfer of the liquid sample towards the vial 10 (then injection towards the analysis apparatus) to be automated by the transfer tube 28 connected to the vial 10 via the lateral duct 26, in some embodiments via the single lateral duct 26, which further enhances the direct and reliable transfer of small liquid samples. Generally speaking, the vial 10 permits automatic transfer of the sample towards analysis apparatus, while maintaining a standard size of the vial 10 that is compatible with this automatic sampler analysis apparatus. In some embodiments, the outer dimensions of the vial 10 may be adapted to permit the vial 10 to be inserted into a standard sampler of an analysis apparatus. In other words, the vial 10 may be sized to be compatible with a standard sampler of an analysis apparatus. This automates the transfer of a liquid sample through the vial 10 towards an analysis apparatus.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone or “A and B.” Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The embodiments of the invention in which an exclusive property or privilege is claimed are defined as follows:

1. A vial for receiving a liquid sample, the vial comprising:
an inner volume and a body with a lateral wall, the body delimiting the inner volume, the vial configured to receive the sample in the inner volume;
an upper opening in the body;
a plug for closing the upper opening;
a septum coupled to the plug, the septum configured to be pierced by a sampling needle for taking the sample; and
a lateral duct through the lateral wall, the lateral duct configured to connect the vial to a transfer tube for transferring the sample in the inner volume of the vial.

2. The vial of claim 1, further comprising a single lateral duct.

3. The vial of claim 1, further comprising an insert in the inner volume, the insert having an internal volume reducing the inner volume of the vial, wherein the insert comprises a passage facing the lateral duct, wherein the lateral duct and the passage are configured to connect the vial to the transfer tube in the internal volume of the insert.

4. The vial of claim 3, wherein the inner volume of the vial is between 1 mL and 3 mL and the internal volume of the insert is between 10 μL and 600 μL.

5. The vial of claim 3, wherein the insert is made of thermoformed polymer.

6. The vial of claim 3, wherein the insert has a wall with a smooth inner surface.

7. The vial of claim 1, wherein the body comprises an attachment interface for attaching the plug, the lateral duct being lower than the attachment interface.

8. The vial of claim 7, wherein the attachment interface is a screw thread.

9. The vial of claim 1, wherein the lateral wall of the body comprises a mistake-proofing device, wherein the mistake-proofing device is configured to orient the vial.

10. The vial of claim 9, wherein the mistake-proofing device is in the form of a flat or of a groove.

11. The vial of claim 1, wherein, transversely to the height, the body further comprises an substantially cylindrical top section and a bottom section shaped cylindrically, spherically, or conically.

12. An analysis assembly, comprising:
an analysis apparatus for analyzing a liquid sample; and
the vial according to claim 1,
wherein the analysis assembly is configured to convey the sample towards the analysis apparatus via the vial by the transfer tube connected to the vial by the lateral duct.

13. The analysis assembly of claim 12, wherein the transfer tube is held by clamping in the lateral duct.

14. The analysis assembly of claim 12, wherein the analysis apparatus is a gas chromatography or high-performance liquid chromatography analysis apparatus.

15. A method for conveying a liquid sample towards an analysis apparatus via the vial according to claim 1, the method comprising:
connecting the transfer tube to the vial via the lateral duct;
transferring the sample into the vial via the transfer tube;
inserting a sampling needle through the septum; and
taking the sample to be analyzed by the analysis apparatus from the vial through the septum via the needle.

16. The method of claim 15, wherein the vial further comprises an insert in the inner volume, the insert having an internal volume reducing the inner volume of the vial, wherein the method further comprises:
transferring the sample into the internal volume of the insert by the transfer tube connected to the vial by the lateral duct of the vial and by a passage in the insert facing the lateral duct; and
taking the sample from the internal volume of the insert through the septum via the needle.

17. The method of claim 15, wherein a sampler supports the vial, wherein the lateral wall of the body of the vial comprises a mistake-proofing device, and wherein the positioning of the vial with respect to the sampler is imposed by the mistake-proofing device.

18. The method of claim 17, wherein the mistake-proofing device is in the form of a flat or of a groove.

19. The method of claim 15, wherein:
the volume of the sample transferred to the vial is between 10 μL and 1 mL; and
the volume of the sample taken from the vial is between 0.1 μL and 100 μL.
